(19) United States
(12) Patent Application Publication
(10) Pub. No.: US 2017/0254390 A1
(43) Pub. Date: Sep. 7, 2017

(54) POWERSHIFT TRANSMISSION FOR WORKING MACHINES

(71) Applicant: ZF Friedrichshafen AG, Friedrichshafen (DE)

(72) Inventor: Norman REGENSCHEIT, Meckenbeuren (DE)

(21) Appl. No.: 15/435,827

(22) Filed: Feb. 17, 2017

(30) Foreign Application Priority Data
Mar. 3, 2016 (DE) 10 2016 203 502.9

(51) Int. Cl. F16H 3/093; B60K 17/34; B60K 17/06

(52) U.S. Cl. CPC F16H 3/093; B60K 17/06; B60K 17/34; F16H 2200/0052; F16H 2200/0091; F16H 2200/0039; F16H 2003/0935; F16H 2003/0818

(57) ABSTRACT

A powershift transmission of a flexible design for a working machine. The powershift transmission has at least six transmission shafts (2, 8, 15, 17, 22, 27, 30) arranged spaced apart from one another. A loose wheel (25), connected to the clutch (26) for the third gear, meshes with a fixed wheel (29) which is connected to the drive output shaft (30) in a rotationally fixed manner.

This application claims priority from German patent application serial no. 10 2016 203 502.9 filed Mar. 3, 2016.

### FIELD OF THE INVENTION

The invention concerns a powershift transmission for working machines.

### BACKGROUND OF THE INVENTION

To drive the vehicle wheels, working machines such as construction machines and in particular backhoe loaders and telehandlers, have to have a powershift transmission with transmission shafts parallel to one another and a distance apart, in order to leave some distance between the drive input shaft and the drive output shaft.

DE 10330159A1 discloses a powershift transmission for construction machines of the type defined in more detail below. The disadvantage of this system is that the options for possible gearwheel pairings are very limited, since the loose wheel on the transmission shaft carrying the clutch for the third gear meshes with the fixed wheel on the transmission shaft carrying the clutch for the second gear. Since the transmission ratios for forward driving should be almost the same as the transmission ratios for driving in reverse, there is little freedom for varying the overall transmission ratio in this transmission system.

### SUMMARY OF THE INVENTION

The purpose of the present invention is to provide a powershift transmission for construction machines, in which the design of the axle separation is more flexible and the options for gearwheel pairing, in particular the possible diameters of the gearwheels, are improved.

This objective is achieved by a powershift transmission of the type concerned which also embodies the characteristics specified in the principal claim.

According to the invention, the transmission shaft for the drive input of the front wheels is decoupled from the transmission shaft with the clutch for the second gear. Thus, the transmission shaft with the clutch for the second gear drives either only the rear wheels of the vehicle, or is only used as a transmission shaft without a drive output shaft for the front wheels or the rear wheels. In this way either the transmission shaft for driving the front wheels can be made as a separate transmission shaft provided with a cut-off clutch, or the separate transmission shaft for driving the rear wheels is at the same time used as the transmission shaft for driving the front wheels. This provides much more freedom for designing the transmission ratios.

### BRIEF DESCRIPTION OF THE DRAWINGS

Further characteristics emerge from the description of the figures, which show:

FIG. 1: A powershift transmission according to the invention, with six forward gears and three reversing gears and a transmission shaft, which acts at the same time as the drive output shaft for driving the front wheels and as the device shaft for driving the rear wheels;

FIG. 2: An arrangement of the wheels of the powershift transmission shown in FIG. 1;

FIG. 3: A powershift transmission with six forward gears and three reverse gears, with a transmission shaft that acts as the drive output shaft for driving the front wheels, and with a cut-off clutch;

FIG. 4: An arrangement of the wheels of the powershift transmission shown in FIG. 3;

FIG. 5: A powershift transmission with three forward gears and three reverse gears, with a transmission shaft that acts as the drive output shaft for the front wheels and for the rear wheels;

FIG. 6: The arrangement of the wheels of the powershift transmission shown in FIG. 5;

FIG. 7: A powershift transmission with three forward gears and three reverse gears, with a transmission shaft for driving the front wheels, and with a cut-off clutch; and

FIG. 8: The arrangement of the wheels of the powershift transmission shown in FIG. 7.

### DETAILED DESCRIPTION OF THE PREFERRED EMBODIMENTS

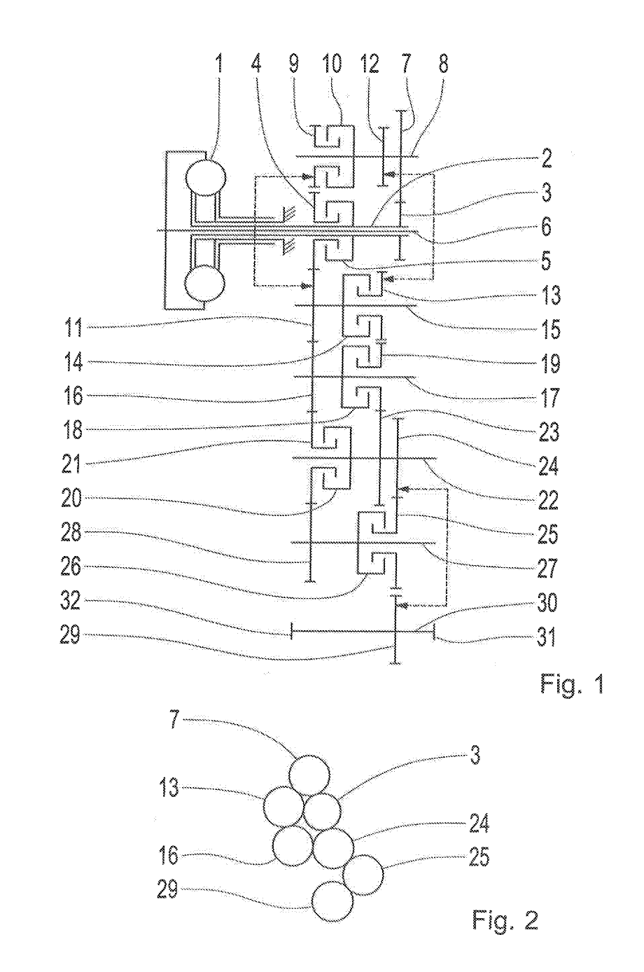

FIG. 1:

By way of the hydrodynamic torque converter 1 a drive motor (not shown), for example a Diesel engine, drives the transmission shaft 2, which is also referred to as the input shaft. The transmission shaft 2 is connected to the fixed wheels 3, “fixed wheel” meaning that the gearwheel is connected to the shaft in a rotationally fixed manner. The loose wheel 4 can be connected to the transmission shaft 2 by means of the clutch 5 for driving in reverse. “Loose wheel” means that the gearwheel is mounted and able to rotate on the transmission shaft. The auxiliary power take-off shaft 6 passes through the transmission shaft 2 and is not referred to as a transmission shaft. The power take-off shaft 6 is provided for driving an auxiliary drive output, for example a hydraulic pump, and is connected directly to the drive motor. The fixed wheel 3 meshes with the fixed wheel 7, which is connected in a rotationally fixed manner to the transmission shaft 8. The loose wheel 9 can be connected to the transmission shaft 8 by means of the clutch for forward driving. The loose wheel 9 meshes with the fixed wheel 11 and the fixed wheel 12 meshes with the loose wheel 13. The fixed wheel 12 is connected rotationally fixed to the transmission shaft 8 and the loose wheel 13 can be connected to the transmission shaft 15 by means of the clutch 14 for the fourth gear. The fixed wheel 11 is connected rotationally fixed to the transmission shaft 15. The fixed wheel 16 meshes with the fixed wheel 11 and is connected rotationally fixed to the transmission shaft 17. By means of the clutch 18 for the first gear the loose wheel 19 can be connected to the transmission shaft 17. By means of the clutch 20 for the second gear the loose wheel 21 can be connected to the transmission shaft 22. The loose wheel 21 meshes with the fixed wheel 16 and the fixed wheel 23 meshes with the loose wheel 19. The fixed wheel 23 is connected in a rotationally fixed manner to the transmission shaft 22 and the fixed wheel 24 is also connected in a rotationally fixed manner to the transmission shaft 22. The fixed wheel 24 meshes with the loose wheel 25, and the loose wheel 25 can be connected by means of the clutch 26 for the third gear to the transmission shaft 27. The fixed wheel 28 is connected rotationally fixed to the transmission shaft 27 and meshes with the loose wheel 21. The loose wheel 25 meshes with the fixed wheel 29, the fixed wheel 29 being connected rotationally fixed to the transmission shaft 30 which forms on the one hand the drive output for the rear wheel 31 and at the same time also the drive output for the front wheel 32.

FIG. 2:

By virtue of the arrangement of the transmission shafts, the fixed wheel 29 can rotate about the loose wheel 25 and the loose wheel 25 can rotate about the fixed wheel 24. In this way the axial distance can be maintained even if the gearwheels have different diameters. With the arrangement shown in FIGS. 1 and 2, six gears in the forward travel direction and three gears in the reversing travel direction can be engaged.

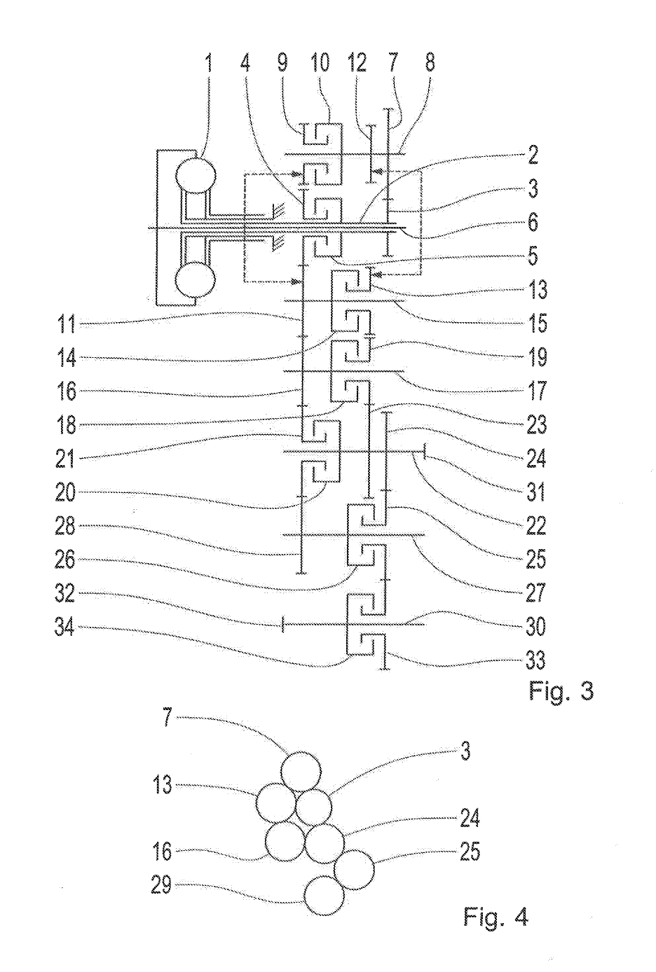

FIG. 3:

The structure of the powershift transmission in FIG. 3 is identical to the structure of the powershift transmission according to FIG. 1, as far as the drive output to the rear wheel 31, which is not arranged on the transmission shaft 30 but instead on the transmission shaft 22. It is true that the drive output to the front wheel 32 is arranged on the transmission shaft 30, but the loose wheel 25 meshes with a loose wheel 33 which can be connected to the transmission shaft 30 by means of the cut-off clutch 34. With this arrangement six gears in the forward travel direction and three gears in the reversing direction can again be obtained.

FIG. 4:

The arrangement of the wheels shown in FIG. 4 is identical to the wheel arrangement shown in FIG. 2.

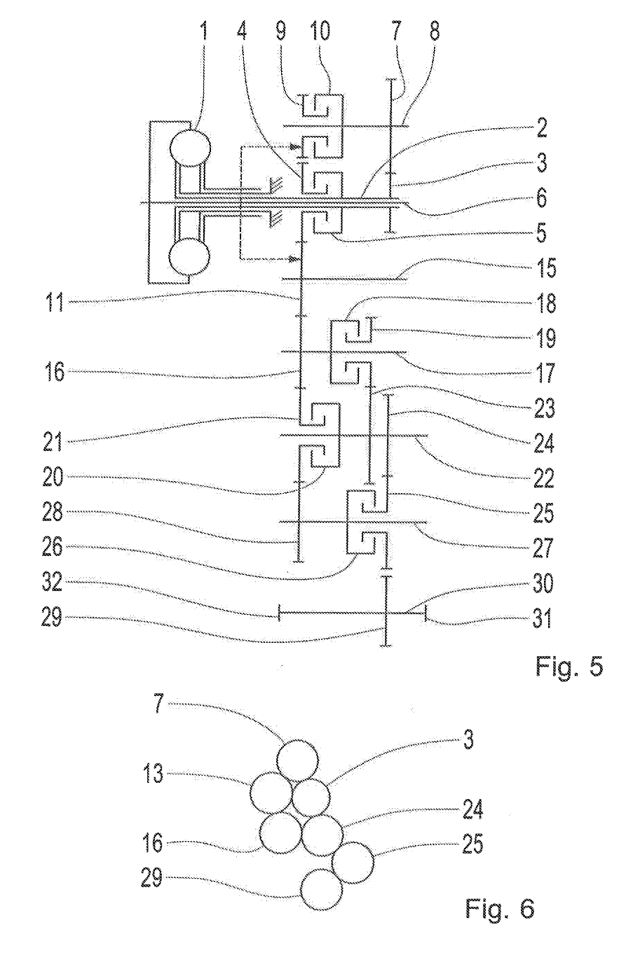

FIG. 5:

The arrangement shown in FIG. 5 is identical to that shown in FIG. 1, except that in FIG. 5 the clutch 14 for the fourth gear and the loose wheel 13 are not present. As a result, in this powershift transmission three gears in the forward direction and three reversing gears can be engaged.

FIG. 6

The arrangement of the wheels shown in FIG. 6 is identical to the wheel arrangement shown in FIG. 2.

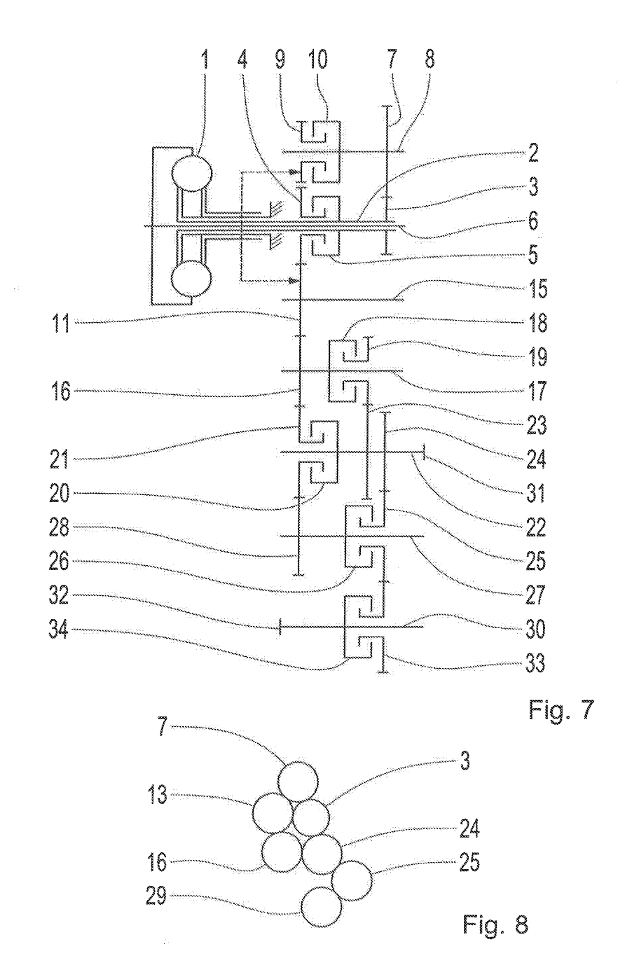

FIG. 7:

The powershift transmission according to FIG. 7 is identical to the powershift transmission shown in FIG. 3, except in that in the powershift transmission according to FIG. 7 the clutch 14 for the fourth gear and the loose wheel 13 are not present. This gives a powershift transmission with three forward and three reversing gears.

FIG. 8:

The arrangement of the wheels shown in FIG. 8 is identical to the wheel arrangement shown in FIG. 2.

### INDEXES

1 Hydrodynamic torque converter
2 Transmission shaft
3 Fixed wheel
4 Loose wheel
5 Clutch for driving in reverse
6 Auxiliary power takeoff shaft
7 Fixed wheel
8 Transmission shaft
9 Loose wheel
10 Clutch for forward driving
11 Fixed wheel
12 Fixed wheel
13 Loose wheel
14 Clutch for the fourth gear
15 Transmission shaft
16 Fixed wheel
17 Transmission shaft
18 Clutch for the first gear
19 Loose wheel
20 Clutch for the second gear
21 Loose wheel
22 Transmission shaft
23 Fixed wheel
24 Fixed wheel
25 Loose wheel
26 Clutch for the third gear
27 Transmission shaft
28 Fixed wheel
29 Fixed wheel
30 Transmission shaft
31 Drive output to the rear wheel
32 Drive output to the front wheel
33 Loose wheel
34 Cut-off clutch

1-7. (canceled)

8. A powershift transmission for a working machine, the powershift transmission comprising:
at least six transmission shafts (2, 8, 15, 17, 22, 27) arranged a distance apart such that a first of the transmission shafts (2) being an input shaft connectable to a hydrodynamic torque converter, and one of the transmission shafts (22, 30) being a drive output shaft for driving rear wheels of the working machine,
a clutch (18) for a first gear being provided on one of the transmission shafts (17),
a clutch (20) for a second gear being provided on another of the transmission shafts (22),
a clutch (26) for a third gear being provided on still another of the transmission shafts (27),
a clutch (10) for forward driving being provided on the transmission shaft (8) for forward driving,
a clutch (5) for reverse driving being provided on the input shaft (2) for driving in reverse,
a loose wheel (25) being arranged on the transmission shaft (27) with the clutch (26) for the third gear,
the loose wheel (25) being in functional meshing connection with a fixed wheel (24, 29), and
the fixed wheel (24, 29) being connected, in a rotationally fixed manner, to the drive output shaft (22, 30) for driving the rear wheels.

9. The powershift transmission according to claim 8, wherein the transmission shaft (22) with the clutch (20) for the second gear is the drive output shaft (31) for driving the rear wheels.

10. The powershift transmission according to claim 9, wherein a transmission shaft (30) is the drive output shaft (32) for driving the front wheels, and on the drive output shaft (32) for driving the front wheels a clutch (34) is provided for connecting the drive output shaft (32) to a loose wheel (33) arranged on the drive output shaft (32) for driving the front wheels such that the loose wheel (33), arranged on the drive output shaft (32) for driving the front wheels, meshes with a loose wheel (25) which is arranged on the transmission shaft (27) with the clutch (26) for the third gear.

11. The powershift transmission according to claim 8, wherein the transmission shaft (30), on which no clutch is arranged, is the drive output shaft (31) for driving the rear wheels and the drive output shaft (32) for driving the front wheels.

12. The powershift transmission according to claim 8, wherein two fixed wheels (23, 24) are arranged on the transmission shaft (22) with the clutch (20) for the second gear, and
only one fixed wheel (16, 28) is respectively arranged on the transmission shaft (17) with the clutch (18) for the first gear and on the transmission shaft (27) with the clutch (26) for the third gear.

13. The powershift transmission according to claim 8, wherein, by selective engaging the clutches (5, 10, 18, 20, 26), three gears in a forward travel direction and three gears in a reversing travel direction are engagable.

14. The powershift transmission according to claim 8, wherein, by selectively engaging the clutches (5, 10, 14, 18, 20, 26), six gears in a forward travel direction and three gears in a reversing travel direction are engageable.

15. A powershift transmission for working machines, the powershif transmission comprising:
at least six transmission shafts arranged spaced apart from one another;
a first shaft of the at least six transmission shafts is an input shaft which is connectable to a hydrodynamic torque converter, and the input shaft having a clutch for engaging a reverse driving;
a second shaft of the at least six transmission shafts having a clutch for engaging a forward driving;
a third shaft of the at least six transmission shafts having a clutch for engaging a first gear;
a fourth shaft of the at least six transmission shafts having a clutch for engaging a third gear, the fourth shaft rotatably supporting a loose wheel such that the loose wheel is rotatable with respect to the fourth shaft, and the loose wheel of the fourth shaft directly meshing with at least a first fixed wheel;
the first fixed wheel being rotationally fixed to a fifth shaft of the at least six transmission shafts, the first fixed wheel of the fifth shaft driving, via an output shaft, rear wheels of the working machine, and the fifth shaft having a clutch for engaging a second gear.

16. The powershift transmission according to claim 15, wherein the fifth shaft, which has the clutch that engages the second gear, is the drive output shaft for driving the rear wheels.

17. The powershift transmission according to claim 16, wherein a sixth shaft of the at least six transmission shafts is a front wheel drive output shaft for driving front wheels of the working machine, and a clutch is provided on the sixth shaft that connects the front wheel drive output shaft to a loose wheel arranged on the drive output shaft, such that the loose wheel on the front wheel drive output shaft meshes with the loose wheel rotatably supported by the fourth shaft and arranged on the fourth shaft with the clutch that engages the third gear.

18. The powershift transmission according to claim 15, wherein a sixth shaft of the at least six transmission shafts, which is free from clutches, is the drive output shaft for driving the rear wheels and a drive output shaft for driving the front wheels.

19. The powershift transmission according to claim 15, wherein the fifth shaft with the clutch for the second gear has the first fixed wheel and a second fixed wheel that are both fixed relative to the fifth shaft, and
only one fixed wheel is respectively provided on each of the third shaft with the clutch for the first gear and the fourth shaft with the clutch for the third gear.

20. The powershift transmission according to claim 15, wherein by engaging the clutches of the third, the fourth and the fifth shafts, three gears in a forward travel direction and three gears in a reversing travel direction are engagable.

21. The powershift transmission according to claim 15, wherein by engaging the clutches of the third, the fourth and the fifth shafts and a clutch of a further shaft, six gears in a forward travel direction and three gears in a reversing travel direction are engagable.
